(19) United States
(12) Patent Application Publication
(10) Pub. No.: US 2008/0286503 A1
(43) Pub. Date: Nov. 20, 2008

(54) Method For Production of Thin-Walled Parts

(76) Inventor: Gerhard Kämpf, Schwabach (DE)

Correspondence Address: COLLARD & ROE, P.C., 1077 NORTHERN BOULEVARD, ROSLYN, NY, 11576, US

(21) Appl. No.: 10/582,009

(22) PCT Filed: Dec. 7, 2004
(86) PCT No.: PCT/DE2004/002684

§ 371 Date: May 23, 2007

(30) Foreign Application Priority Data
Dec. 9, 2003 (EP) 03028315.4

(51) Int. Cl. B29C 41/12; B29C 41/02; B32B 1/08

(52) U.S. Cl. 428/34.1; 264/71; 425/469

(57) ABSTRACT

The invention relates to a method for producing thin-walled parts made of molding material by moving a first and an additional shaping tool relative to one another. According to the inventive method, a hollow space of the first shaping tool or another part that is inserted into the first shaping tool is filled with pourable molding material, and a thin-walled zone made of molding material is created between an exterior wall area of the additional shaping tool and an interior wall area of the shaping tool by moving the first and the additional shaping tool relative to each other so as to partially displace the molding material.

The invention relates to a method for production of thin-walled components composed of castable material by relative movement of a first and of a further shaping tool with respect to one another. The invention also relates to a thin-walled component produced using a method such as this, and to a tool system for production of a thin-walled component using a method such as this.

The injection-molding process for production of plastic parts, is known, inter alia, as prior art for the production of thin-walled components. One disadvantage of this method is that only components with a limited length can be produced owing to the restricted flowing capability, despite the addition of flowing aids.

The invention is based on the object of offering a method for production of thin-walled components, which allows the production of thin-walled components of virtually unrestricted length. A further aim is to offer a component produced using this method, and a tool system for carrying out the method.

This object is achieved by a method having the features of patent claim 1. For the component, the object is achieved by the features of patent claims 8 and 9, and for the tool system it is achieved by the features of patent claim 10.

In the method according to the invention, a cavity in a further component, which has been inserted into the first shaping tool, or a cavity in the first shaping tool is firstly filled with a castable material which can flow (for example molten material). In a second method step, the first and the further shaping tool are moved relative to one another with partial displacement of the castable material taking place and with a desired thin-walled area composed of castable material being formed between an outer wall area of the further shaping tool and an inner wall area of the cavity (of the inserted further component or of the first shaping tool).

Thermoplastic melts, metal melts and/or reaction resins which can flow may be used, inter alia, as castable materials. These materials may additionally be enriched with fillers, reinforcing agents (for example ceramic elements, glass fibers, carbon fibers).

In contrast to an injection-molding process according to the prior art, components with extremely thin walls can be produced with a virtually unrestricted component length since material removal which can be quantified precisely can be carried out by the second method step of partial displacement of the castable material. Furthermore, the cavity to be filled is completely or partially filled in the first method step without there being any limit, which would restrict the method, in terms of the length of the cavity.

According to a first method variant, the castable material can predominantly or completely fill the cavity after the filling process.

According to a further method variant, the castable material can partially fill the cavity after the filling process.

During the displacement of the castable material by the relative movement of the first and of the further shaping tool with respect to one another, all of the material which is no longer required for the formation of the thin wall layer of the thin-walled component is removed, is displaced and if required is fed on for further (renewed) use, with the cavity being completely filled with castable material.

If a cavity is filled only partially, a film of the castable material can be drawn into a gap area between the inner wall area of the cavity and the outer wall area of the further shaping tool by the first and the further shaping tool moving toward one another.

The desired thin wall of the thin-walled component is thus produced during the relative movement of the first and of the further shaping tool with respect to one another in a gap area between the inner wall area of the cavity and the outer wall area of the further shaping tool, by means of the castable material.

In general, in all of the method variants, additional castable material can be fed in subsequently in order to be able to supply castable material to any desired point during the process.

According to a further method variant, at least one further functional element can be sprayed on to the component, such as a connecting element or a mounting element (for example a projection, an end disk, a winding disk, a winding aid) which can be used as a mounting element during the subsequent further processing or further machining of the component in order to replace an additional mounting tool, and can be removed from the component again after assembly.

According to one particularly advantageous method variant, the described method is used for introduction of thin-walled insulation composed of castable material into slots in stator laminates for an electrical machine. In this case, the slots of a plurality of stator laminates, which are arranged one behind the other in the first shaping tool, are filled. These slots form an elongated cavity, which can be filled, when arranged in a row.

The described method according to the invention makes it possible to jointly fill and insulate a multiplicity of stator laminates arranged one behind the other. In contrast to an injection-molding process, there are also no restrictions in this case with regard to the number of stator laminates which can be arranged one behind the other, and thus to the length and size of the electrical machine.

The method according to the invention makes it possible to produce thin-walled insulation with a thickness of in particular 0.1 mm to 1 mm within the individual slots in the stator laminates, in which, when arranged one behind the other, the stator laminates may have virtually any desired length thus making it possible, in particular, to produce even large motors.

The ratio of the wall thickness to the length of the component may in this case in particular be less than a factor of 2.5×10⁻³ (that is to say for example a component with a wall thickness of 0.3 mm and a length of more than 120 mm), so that it is economically possible to produce very thin-walled components, which are very long at the same time.

The thin-walled component according to the invention, which is produced using the described method, can be designed virtually without any restrictions in order to minimize the wall thickness and to maximize the length of the respective component. The method according to the invention also makes it possible to configure the wall thickness of the thin-walled component to be different, and to model it precisely.

The thin-walled insulation according to the invention and composed of castable material in slots for stator laminates can be produced in a time-saving manner without any restrictions in terms of motor size and thus the number of stator laminates arranged one behind the other. There is therefore no need for the complex insulation and handling of stator laminates required in the past.

In the tool system according to the invention, at least one first and second shaping tool (possibly also further tools) are provided, and can be moved relatively toward one another. In the final position, a gap area which may have any desired dimensions and represents the thin wall of the thin-film component can be provided between the outer area of the further shaping tool and the inner area of the cavity (of the component inserted in the first shaping tool or of the first shaping tool itself).

The invention will be explained in more detail with reference to exemplary embodiments in the drawing figures, in which:

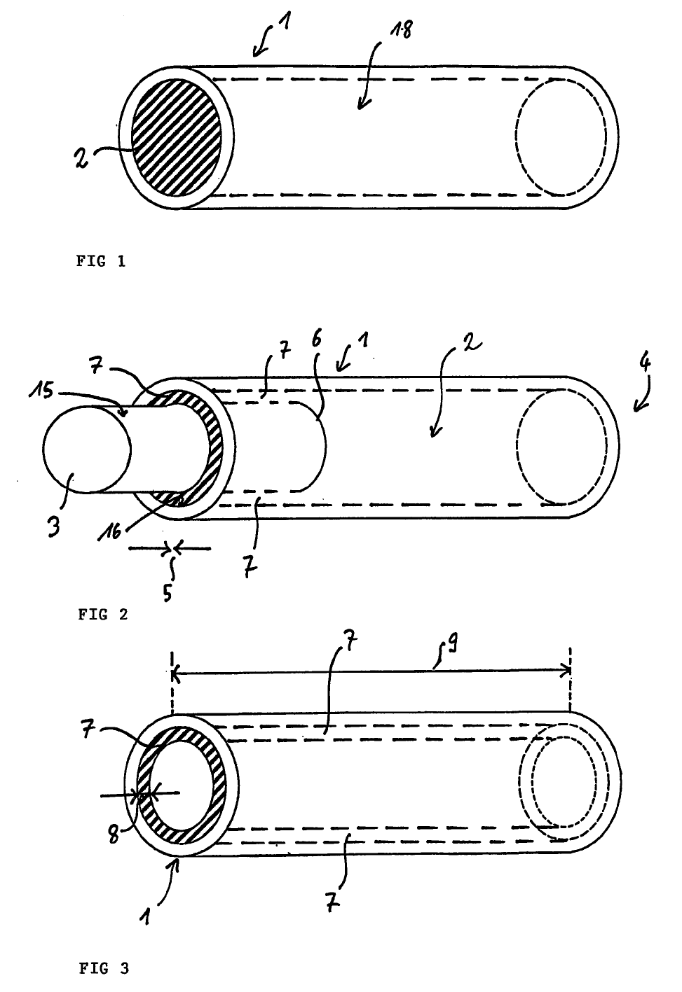

FIG. 1 shows a cavity, filled with castable material, in a first shaping tool,

FIG. 2 shows a tool as shown in FIG. 1, with a further shaping tool having partially penetrated into it, and with material being partially displaced,

FIG. 3 shows the tool as shown in FIG. 1 after removal of the further shaping tool, with a circumferential wall layer applied,

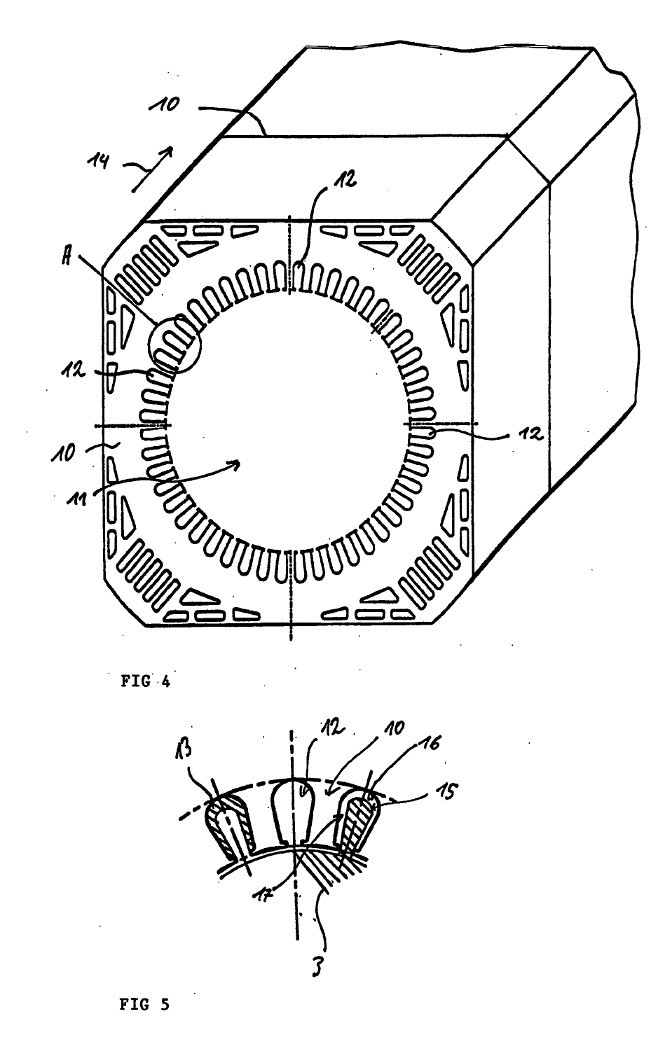

FIG. 4 shows a schematic illustration of a core composed of stator laminates for an electrical machine with slots for the fitting of insulation, and

FIG. 5 shows an enlarged illustration A from FIG. 4.

FIGS. 1 to 3 show various method steps in the method according to the invention.

FIG. 1 shows a schematic illustration of an (outer) shaping tool 1 (in this case a hollow cylinder) which has been completely filled with (liquid), molten castable material 2 according to the first method step, so that the inner cavity 18 has also been filled.

As the next method step, as shown in FIG. 2, a movement takes place into the shaping tool via a further shaping tool 3 (in this case; a die), as a result of which the castable material 2 that is located there is displaced and, for example, can emerge on the rear face 4 of the shaping tool 1, or at some other point.

FIG. 2 shows the shaping tools 1 and 3 which have been moved relatively toward one another in the direction 5, in a mid-movement position. The castable material 2 is displaced on the front end area 6 of the shaping tool 3. Once the further shaping tool 3 has been passed completely through the shaping tool 1, a wall layer 7 which may have indefinitely thin walls and which can be removed from the first shaping tool 1 as a sleeve is produced by complete material removal of the castable material 2 between an outer wall area 15 of the further shaping tool 3 and an inner wall area 16 of the shaping tool 1.

The geometry of the wall layer 7 (for example of thickness 8) can be configured individually as a function of the shape of the further shaping tool 3. For example, this means that it is also possible to produce different thicknesses 8 in places. The method according to the invention is not subject to any restrictions in terms of the length 9 of the resultant component. In contrast to the injection-molding process in which the injection depth is restricted because of the restricted flowing capability of the materials used, the proposed method makes it possible to produce virtually any desired combination in terms of minimizing the wall thickness 7 and maximizing the length 9 of the component.

The relative movement can in this case be achieved either by movement of the first shaping tool 1 or of the further shaping tool 3, or of both shaping tools 1 and 3. Furthermore, in addition to a linear movement, a tool 1 and/or 3, in particular the tool 3, can also carry out a rotary movement or a shaking movement.

FIG. 4 shows a stator laminate 10, as is known per se, for an electrical machine with a rotor opening 11. Circumferentially, the stator laminate 10 has a multiplicity of slots 12, into which insulation 13 must be introduced, as shown in the enlarged illustration A in FIG. 5.

As shown in FIG. 4, a plurality of stator laminates 10, which are not illustrated in detail, are arranged one behind the other in order to form the motor length. In this case, according to the prior art, insulation (“slot cell insulation”) which must be fitted into the slots 12 was in the past provided between the stator winding (not illustrated), which is held in the slots 12 and the stator laminates 10 by means of multiple layers of insulating paper, which had to be cut to size, folded and fitted individually into the respective slots 12, using special machines.

The method according to the invention makes it possible to provide insulation 13 (for example composed of polycarbonate) as shown in FIG. 5 by means of the method steps according to the invention. In this case, all of the circumferentially arranged slots 12 in a stator laminate 10 can be produced at the same time in one process step and can be provided for any desired arrangement of stator laminates 10 which are arranged one behind the other in the direction 14.

FIG. 5 also shows a partial section illustration of a further tool 3 which can be shaped, with circumferentially arranged outer wall areas 15 which are separated via gap areas 17 from the inner wall areas 16 of the circumferentially arranged slots 12 in stator laminates 10, which are inserted one behind the other in a first shaping tool 1, for an electrical machine.

In this case, FIG. 5 shows only a single outer wall area 15, in which case the number of outer wall areas 15 which are arranged circumferentially on the tool 3 actually corresponds to the number of slots 12 to be provided with thin-walled insulation 13.

### REFERENCE SYMBOLS

1 Shaping tool
2 Castable material
3 Shaping tool
4 Direction
5 Rear face
6 End area
7 Wall layer
8 Thickness
9 Length
10 Stator laminate
11 Rotor
12 Slot
13 Insulation
14 Direction
15 Outer wall area
16 Inner wall area
17 Gap area
18 Cavity

1: A method for production of thin-walled components composed of castable material by relative movement of a first and of a further shaping tool with respect to one another, having the following method steps:
a cavity in a further component, which has been inserted into the first shaping tool, or in the first shaping tool is filled with a castable material which can flow,
the first and the further shaping tool are moved relative to one another with partial displacement of the castable material in order to produce a thin-walled area composed of castable material between an outer wall area of the further shaping tool and an inner wall area of the cavity.

2: The method as claimed in claim 1, wherein the castable material predominantly or completely fills the cavity after the filling process.

3: The method as claimed in claim 1, wherein the castable material partially fills the cavity after the filling process.

4: The method as claimed in claim 3, wherein the castable material which is located there is displaced by relative movement of the first and of the further shaping tool into a gap area between an inner wall area of the cavity and an outer wall area of the further shaping tool.

5: The method as claimed in claim 1, wherein a film of the castable material is drawn by relative movement of the first and of the further shaping tool with respect to one another into a gap area between an inner wall area of the cavity and an outer wall area of the further shaping tool.

6: The method as claimed in claim 1, wherein additional castable material is fed in subsequently.

7: The method as claimed in claim 1, for introduction of thin-walled insulation composed of castable material into slots in stator laminates of an electrical machine, wherein the slots of a plurality of stator laminates which are arranged one behind the other in the first shaping tool form a cavity which can be filled with castable material.

8: A thin-walled component composed of castable material, produced by a method as claimed in claim 1.

9: The thin-walled insulation composed of castable material in slots in stator laminates of an electrical machine, produced using a method as claimed in claim 1.

10: A tool system comprising a first shaping tool (1) and a further shaping tool (2), wherein the first and the further shaping tool (1, 2) can be moved relative to one another in order to produce thin-walled components composed of castable material using a method as claimed in claim 1.

11: The tool system as claimed in claim 10, having a further shaping tool (2) with circumferentially arranged outer wall areas (15), which are separated via gap areas (17) from slots (12), which are arranged circumferentially on the inner wall areas (16), in stator laminates (10), which are inserted one behind the other in a first shaping tool (1), for an electrical machine.
